(19) United States
(12) Patent Application Publication
(10) Pub. No.: US 2016/0075842 A1
(43) Pub. Date: Mar. 17, 2016

(54) POLYMERIC FOAM

(71) Applicant: DSM IP ASSETS B.V., Heerlen (NL)

(72) Inventors: Hendricus Franciscus AUSSEMS, Echt (NL); Paul Willem Jan VAN DEN HEUVEL, Echt (NL)

(21) Appl. No.: 14/784,783

(22) PCT Filed: Apr. 11, 2014
(86) PCT No.: PCT/EP2014/057348

§ 371 Date: Oct. 15, 2015

(30) Foreign Application Priority Data
Apr. 17, 2013 (EP) 13164042.7

(51) Int. Cl. C08J 9/00

(52) U.S. Cl. CPC C08J 9/00; C08J 2367/02

(57) ABSTRACT

Polymeric foam, characterized in that the polymeric foam is produced from a polymer composition comprising a polyester containing monomeric units of a dimerised fatty acid and/or a derivative thereof and further monomer units of at least one dicarboxylic acid and at least one diol, which polymer composition is uncrosslinked.

The invention relates to a polymeric foam. Polymeric foams are widely known for many years. A polymeric foam in general consists of a polymeric matrix and gaseous cells or foam cells embedded in the matrix. The foam cells comprise a gas, often the blowing agent or a gas originating from the blowing agent that normally is replaced by air through diffusion. Polymeric foams exist with a density just below the density of the unfoamed polymer to densities far below the density of the unfoamed polymer.

A special class of polymeric foams is formed by the elastic polymeric foams, for instance foams of flexible polyurethanes and foams of ethylene vinylacetate copolymer (EVA). Of these foams the EVA foam is used in shoe soles, especially in soles of sporting shoes. This because of the elastic properties and the resistance against compression of the EVA foam. These properties enhance the performance of the athlete wearing the shoes.

A problem with the EVA foam is that it is difficult to recycle the foam, because the foam has been cross-linked.

Object of the present invention is to provide a polymeric foam that has not been cross-linked and that nevertheless has the elastic properties and the resistance against compression of the EVA foam or even better.

Surprisingly this object is obtained if the polymeric foam comprises a polymer composition comprising a polyester containing monomeric units of a dimerised fatty acid and/or a derivative thereof and further monomer units of at least one dicarboxylic acid and at least one diol, which polymer composition is uncrosslinked.

Because the polymer composition has not been cross-linked, the foam may be molten and processed as a thermoplastic polymer. Because of the presence of the monomeric units of a dimerised fatty acid and/or a derivative thereof in the polyester, the polyester shows an elastomeric nature, so providing the polymeric foam with the excellent elastic properties. It is not necessary to cross-link the foam to obtain sufficient low densities. In this way the foam is suitable to be applied in soles of sporting shoes and the foam can easily be recycled.

The dimerised fatty acids may be obtained from monomeric unsaturated fatty acids by an oligomerisation reaction. The oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acids are saturated.

It is also possible that the polyester of the polymer composition of the polymeric foam contains monomer units of derivatives of dimerised fatty acid. For example a dimerised fatty diol may be obtained as a derivative of the dimerised fatty acid by hydrogenation of the carboxylic acid groups of the dimerised fatty acid, or of an ester group made thereof. Further derivatives may be obtained by converting the carboxylic acid groups, or the ester groups made thereof, into an amide group, a nitril group, an amine group or an isocyanate group.

The dimerised fatty acids may contain from 32 up to 44 carbon atoms. Preferably the dimerised fatty acid contains 36 carbon atoms.

Further details relating to the structure and the properties of the dimerised fatty acids may be found in the corresponding leaflet “Pripol C36-Dimer acid” of the company UNICHEMA (Emmerich, Germany) or in the brochure of the Company COGNIS (Düsseldorf, Germany) “Empol Dimer and Poly-basic Acids; Technical Bulletin 114C (1997)”.

In the production of the polyester of the polymeric foam the dimerised fatty acid can be used as a monomer or as a pre-cursor oligomer or polymer. In one example the pre-cursor polymer is a polyester, formed of dimerised fatty acid and/or dimerised fatty diol with any combination of diols or dicarboxylic acids. In another example the pre-cursor polymer is a polyamide, formed of dimerised fatty acid and/or dimerised fatty diamines with any combination of diamines or dicarboxylic acids forming polyamides. It is also possible that the pre-cursor polymer is a polyester-amide.

The dicarboxylic acid may be aliphatic or aromatic. Suitable aliphatic dicarboxylic acids include oxalic acid, succinic acid, fumaric acid, suberic acid, sebacic acid and cyclohexane dicarboxylic acid. Suitable aromatic dicarboxylic acids include terephthalic acid, isophthalic acid, ortho-phthalic acid, naphthalene-dicarboxylic acid and para-phenylene dicarboxylic acid. Preferably at least one aromatic dicarboxylic acid is terephthalic acid or naphthalene dicarboxylic acid. Preferably at least 80 mol. %, more preferably at least 90 mol. %, most preferably at least 98 mol. % of the monomer units of dicarboxylic acids of the further monomer units are one or more aromatic dicarboxylic acids. The balance of the dicarboxylic acids of the further monomer units may contain of aliphatic dicarboxylic acids.

Suitable diols are aliphatic diols including for example ethylene glycol, 1,3-propylene glycol, 1,4-butanediol, 1,6-hexanediol, neopentyl glycol, trimethylene glycol, tetramethylene glycol, cyclohexane dimethanol. An example of a suitable aromatic diol is 2,2-bis (4-hydroxyphenyl) propane. Sugar based diols, like for instance isosorbide, isomannite or isoidide may also be used. Preferably greater than 50, more preferably greater than 70, particularly greater than 90, and especially greater than 95 and up to 100 mole % of the diols are aliphatic glycol (s), preferably ethylene glycol and/or 1,4-butanediol.

In a particularly preferred embodiment of the invention, the further monomer units are 1,4-butanediol and terephthalic acid, ethylene glycol and terephthalic acid, ethylene glycol and naphthalene dicarboxylic acid, 1,4-butanediol and naphthalene dicarboxylic acid or mixtures thereof. Most preferably the further monomer units are 1,4-butanediol and terephthalic acid.

The copolyester of the polymeric foam may further contain units of one or more polyether diols, for example poly(ethylene glycol), poly(propylene glycol), more particular poly-1,3-propylene glycol or poly-1,2-propylene glycol, poly(tetramethylene glycol), poly(hexamethyleneglycol), poly(ethylene glycol-tetramethylene glycol)copolymer, poly(ethylene glycol-propylene glycol)copolymers etc.

Preferably the polyester consists for at least for 95 wt %, more preferably 98 wt. % of monomeric units of dimerised fatty acid and/or one or more derivatives thereof, 1,4-butanediol and terephthalic acid.

Preferably the polyester contains between 10 and 80 wt. % of the monomer units of the dimerised fatty acid and/or a derivative thereof, more preferably between 20 and 70 wt. %, even more preferably between 30 and 50 wt. %. This ensures a high melting point of the copolymer and a high flexibility and good low temperature properties.

Examples of the preparation of such polyesters are described in for example Handbook of Thermoplastics, etc. O. Olabishi, Chapter 17, Marcel Dekker Inc., New York 1997,ISBN 0-8247-9797-3, in Thermoplastic Elastomers, 2nd Ed, Chapter 8, Carl Hanser Verlag (1996) ISBN 1-56990-205-4, in Encyclopaedia of Polymer Science and Engineering, Vol. 12, Wiley & Sons, New York (1988), ISBN 0-471-80944, p.75-117 and the references cited therein.

During or after the production of the polyester additives may be added. These additives can function as anti-oxidants, UV-absorbers, nucleating agents, dies or pigments, and anti-static agents. Stabilizers that can be used for example are hindered phenol antioxidants such as 1,3,5-trimethyl-2,4,6-tris(3,5,-di-t-butyl-4-hydroxybenzyl) benzene, and 3,9-bis{2-[3-(3-t-butyl-4-hydroxy-5-methylphenyl)-propionyloxyl-1,1-dimethylethyl}-2,4,8,10-tetraoxaspiro[5,5] undecane or stabilizers such as tris(2,4-di-t-butylphenyl)phosphite, trilauryl phosphite, 2-t-butyl-alpha-(3-t-butyl-4-hydroxyphenyl)-p-cumenyl-bis(p-nonylphenyl) phosphite, Examples of the above ultraviolet absorbers include, for example, p-t-butylphenyl salicylate, 2-hydroxy-4-methoxybenzophenone, 2-hydroxy-4-methoxy-2′-carboxybenzophenone, 2,4,5-trihydroxy-butylophenone, and so on. Examples of the above nucleating agents are talcum, carboxylic acid salts like sodium benzoate and sodium stearate, titanium oxide and so on.

The polymer composition comprising the polyester preferably comprises at least 50 wt. % of the polyester, more preferably at least 75 wt. % of the polyester, most preferably at least 90 wt. % of the polyester. The polymeric foam may be obtained by using a chemical or a physical blowing agent. Examples of chemical blowing agents include citric acid and potassium bicarbonate.

Examples of physical blowing agents include carbon dioxide and ExpancelTM The polymeric foam may be produced by an extrusion process or by an injection moulding process. For example to produce shoe soles, the foam may be injected in a mould, to obtain the final shape in one step. It is also possible that a foam plate is extruded, and that later by thermoforming of the plate the foam is processed into its final shape.

The polymeric foam may be used in furniture, shoe soles, car seating, noise damping panels, personal protection etc. Preferably the polymeric foam is used in shoe soles, more preferably in shoe soles of sporting shoes, most preferably as inner sole and/or mid sole in sporting shoes. Examples of sporting shoes include shoes for running, shoes for volleyball, soccer, hiking, basketball etc.

### EXAMPLES

### Materials Used

Amite™ PL381, a thermoplastic polyester elastomer comprising polyether soft blocks, delivered by DSM, the Netherlands.
Arnitel™ EB464, a thermoplastic polyester elastomer comprising polyether soft blocks, delivered by DSM, the Netherlands.
Arnitel™ ECO L-X07135, a thermoplastic elastomer comprising monomer units of a dimerised fatty acid, 1,4-butane diol and terephthalic acid, delivered by DSM, the Netherlands.
Hydrocerol HK 70, a physical blowing agent based on citric acid.

### Preparation of the Foam

3000 gr/hour of the polymer was fed to a Schwabenthan single screw extruder having a screw diameter of 30 mm. The screw speed was about 45 rpm, the barrel temperature of the extruder was between about 200 and 220° C. Between the barrel end and the die head 3 Sulzer mixers had been mounted. A slit die having a slit of 20×0.75 mm was used.

### Measurement of the Density of the Foam

The foam density was determined by weighing a foam sample and determining the volume of the sample by measuring the water displacement of the sample.

### Example I

A composition consisting of 97 wt. % Arnitel™ ECO L-X07135 and 3 wt. % Hydrocerol were processed into a foam strip as explained above. The density of the foam was 495 kg·m⁻³.

### Comparative Experiment A.

A Composition consisting of 97.2 wt. % of Arnitel™ PL381 X07135 and 2.8 wt. % Hydrocerol were processed into a foam strip as explained above. The density of the foam was 690 kg·m⁻³.

### Comparative Experiment A

A Composition consisting of 97.2 wt. % of Arnitel™ EB464 and 2.8 wt. % Hydrocerol were processed into a foam strip as explained above. The density of the foam was 830 kg·m⁻³.

From the results of the example and the comparative experiments it is clear that the foam density obtained with the polymeric foam comprising the polyester containing monomer units of dimerised fatty acids is much lower than of the other polymeric foams.

1. Polymeric foam, characterized in that the polymeric foam is produced from a polymer composition comprising a polyester containing monomeric units of a dimerised fatty acid and/or a derivative thereof and further monomer units of at least one dicarboxylic acid and at least one diol, which polymer composition is uncrosslinked.

2. Polymeric foam according to claim 1, wherein the copolymer consists for at least 80 wt. % of monomeric units of dimerised fatty acid and/or one or more derivatives thereof, 1,4-butanediol and terephthalic acid.

3. Polymeric foam according to claim 1, wherein the copolymer consists for at least 98 wt. % of monomeric units of dimerised fatty acid and/or one or more derivatives thereof, 1,4-butanediol and terephthalic acid.

4. Polymeric foam according to claim 1, wherein the copolymer contains between 10 and 80 wt. % of the monomer units of the dimerised fatty acid and/or a derivative thereof.

5. Polymeric foam according to claim 1, wherein the copolymer contains between 30 and 50 wt. of the monomer units of the dimerised fatty acid and/or a derivative thereof.

6. Shoe sole comprising the polymeric foam according to claim 1.

7. Shoe sole according to claim 7, wherein the shoe sole is a shoe sole of a sporting shoe.
